(19) United States
(12) Patent Application Publication
(10) Pub. No.: US 2010/0107492 A1
(43) Pub. Date: May 6, 2010

(54) Forb highly attractive to and good for whitetail deer

(76) Inventor: Sharif Adham Safwat, Bainbridge Island, WA (US)

Correspondence Address: Donald E. Schreiber;A Professional Corporation, Post Office Box 2926, Kings Beach, CA, 96143-2926, US

(21) Appl. No.: 12/589,904

(22) Filed: Oct. 29, 2009

Related U.S. Application Data
(60) Provisional application No. 61/197,706, filed on Oct. 29, 2008.
(60) Provisional application No. 61/216,647, filed on May 19, 2009.

(51) Int. Cl. C09K 17/00; A01G 7/00

(52) U.S. Cl. 47/58.1 SC; 47/58.1 SE

(57) ABSTRACT

One aspect of the present disclosure is a method for preconditioning a whitetail deer forage plot. The disclosed whitetail deer forage plot preconditioning method includes the steps of:
1. selecting an area of soil to be preconditioned in a locale accessible to whitetail deer; and
2. sowing plant seed in the selected area of soil that includes Lapsana communis seed.
   In another aspect, the present disclosure is a method for preparing a seed blend for use in sowing a forage plot for whitetail deer. The seed blend preparation method includes the steps of:
1. selecting a seed type other than Lapsana communis seed for inclusion in the seed blend; and
2. combining a first quantity of plant seed of the selected seed type other than Lapsana communis seed with second quantity of Lapsana communis seed to thereby produce the seed blend.

### CLAIM OF PROVISIONAL APPLICATION RIGHTS

This patent application claims the benefit of U.S. Provisional Patent Application Nos. 61/197,706 filed on Oct. 29, 2008, and 61/216,647 filed on May 19, 2009.

### BACKGROUND

1. Technical Field

The present disclosure relates generally to preconditioning wildlife foraging areas; and more particularly to preconditioning such a foraging area specifically to attract various species of deer, e.g. whitetail deer, blacktail deer, coues deer and mule deer, etc., and to seeds and seed blends useful in preconditioning foraging plots for wild deer.

2. Background Art

Individuals plant forage plots primarily to attract deer to a particular location. The term “attract,” “attractant” or “attractive” as used herein means to reliably and regularly induce wild deer to visit a particular location and browse a particular forb, i.e. a broad-leaved herb other than a grass. The term “highly attractive” for the purpose of the present disclosure shall mean a forb so attractive to wild whitetail deer that deer not otherwise deterred reliably visit and browse plots of such forb for at least a majority of days during a particular interval.

However, despite a plethora of advertisements from various manufacturers of wild deer forage forbs advertised as allegedly attractive to deer including highly attractive to deer, thus far a deer forage forb has not been identified that is so attractive to deer that deer feel compelled to visit a forage plot of such forb and/or including such forb despite the presence of their normally preferred native browse. That is, it is safe to say that despite the plethora of commercial claims to the contrary, no one has yet proposed a wild whitetail deer forage forb that is highly attractive to such deer beginning in early spring even in locales that are too cold to grow beans in the springtime. Furthermore, no one has proposed such a forb that has the additional advantage of enhancing antler growth and increasing antler size (including “increasing antler mass”; “improving antler mass”; “growing bigger deer”; “growing bigger bucks”; “growing better deer”; “growing better bucks”; “maximizing antler growth”; “maximizing antler size”; and terms having similar connotations and meanings). This is especially so since the only other known wild whitetail deer forage forb capable of attracting deer during early springtime, i.e. spring green-up, are certain forage beans. Unfortunately, these bean forbs do not grow well at a time or in a location where soil temperatures are not averaging above about 65 degrees Fahrenheit (“° F.”). Consequently, these bean forbs are incapable of attracting the wild deer when they are not growing during the earliest portions of springtime such as spring green-up. Furthermore, when such beans are grown, they usually are soybean variants. Due to the presence of high levels of thyroid inhibiting compounds and heat stable estrogens in soybean variants, such beans do not actually improve antler growth, and are even likely to impair antler growth.

It is safe to say that the entire deer forage forb industry focuses its activities on creating and marketing forbs that primarily are as attractive as possible to wild deer, and that to a lesser extent also are capable of providing nutrients to the deer that enhances antler growth of the deer and maximize antler size and mass. It is also safe to say that while enhancing antler growth is a major interest within the industry, unless a particular forb attracts deer they will not browse the forb. Consequently, the primary concern of the wild deer forage industry is identifying forbs that are most attractive to deer.

Then, there are other goals those in the industry strive to attain while also finding a maximally attractive wild deer forb. Primarily, the other goals for those providing deer forage forb seeds are:
1. ease of planting and producing forage plots using seeds of the forb;
2. ease of harvesting seed from and reproducing seed of such forb;
3. a low seed cost; and
4. a species of forb that grows well and quickly in a range of climates and soil types.

Deer are known to browse a plethora of various plants including forbs. As used herein and as used in scientific literature, the term “browsed” does not mean “attractive to”, but rather means “eaten” or “not toxic too.” Some species of dear actively browse particular forbs at certain times of year that other deer species otherwise normally browse at a different time of year. Because deer browse a plethora of plants, there exists no guarantee that deer browsing a particular plant at a particular time or location indicates that the plant attracts deer well enough to warrant cultivating that plant specifically to attract deer. Furthermore, there exists no guarantee, hint or suggestion to anyone that a forb or other plant browsed by deer and not having had its effect on antler growth or mass already objectively evaluated increases deer antler size and mass, or deer healthfulness and survival rate. Furthermore, there exists no guarantee that forage eaten regularly or at a certain time of year by one deer specie is attractive to another deer specie at a similar time of year. In fact, it is a widely held belief that a forb browsed by red deer are not necessarily attractive to wild whitetail deer, mule deer, coues deer and blacktail deer. Consequently, because deer eat a particular plant does not provide any hint or suggestion that plant may be used advantageously to attract deer to feed at a particular location. Particularly if a larger ruminant, e.g. red deer, eat a certain plant, it is widely held that there is no hint or suggestion that wild whitetail deer find such a plant attractive.

For example, wild whitetail deer are known to eat grass, but can become sick and die in a pasture in which cattle thrive, or in which even other deer thrive. During spring and summer whitetail deer ignore certain plants that red deer are known to eat year-round. Whitetail deer actually cannot survive on forage on which other types of deer thrive. Forage seed mixes that include brome grass are sold for seeding wild deer plots including plots intended to attract whitetail deer. However, it is unknown whether brome grass improves whitetail deer antler growth, nor even if whitetail deer prefer brome grass.

Wild deer do not necessarily eat plants and plant fruit eaten by humans. It is well known that deer do not eat certain leafy plants and fruits sought out and eaten by humans. For example, it is a widely held belief that deer love to eat apples. However, experiments have established that wild deer shun varieties of apples propagated and enjoyed by humans. For another example, it is thought that deer enjoy plums. However, experiments have established that wild deer do not eat certain plums propagated and enjoyed by humans. Thus, because whitetail deer browse a particular plant, a plant's leaves or its fruit does not hint or suggest that it is attractive, highly attractive or sufficiently attractive to wild whitetail deer to make its deliberate cultivation in a wild whitetail deer forage plot advantageous. Furthermore, there exists no hint or suggestion that a plant consumed by humans is capable of enhancing antler grow or increasing antler mass in wild whitetail deer, nor that deer are attracted to such plant during spring green-up, spring, early summer, summer, fall or any other time. Conversely, some plants, plant fruit or plant leaves, for example cherry tree leaves, that are highly attractive to deer, may be poisonous to humans and other animal species.

Furthermore, deer eat many plants in limited quantity solely to acquire substances that support the microbes living in and on the lining of the deer's ruminating chamber that the deer needs for digesting consumed forage. For example, deer may eat a certain plant at a particular time while avoiding that plant at other times only because the plant at a particular time has a certain amount of sulphur needed by the deer's mircofauna.

Even some forbs whose seeds are sold commercially for seeding deer forage plots do not actually attract deer unless some other circumstance exists. For example, brassicas grown from seed marketed by Mossy Oak Biologic Seed Co. are not considered to be attractive to deer until a suitable frost occurs. It appears that exposure to frost stimulates bio-chemical changes within the brassicas that make them attractive to deer. Consequently, these types of brassicas are unsuitable for attracting deer until after a hard frost, and usually until after both a hard frost and a sustained period of freezing temperatures occurs. Thus such brassicas are not attractive until after a fall frost or winter frost.

Another example of plants whose seeds are sold commercially for seeding plots for feeding and/or attracting deer that do not actually attract deer unless some other circumstance exists are clovers. Clovers are considered a favorite forb for attracting deer to a particular location as well as for supplying sufficient minerals and protein to assist deer in growing antlers. However, wild deer typically do not find clover forage plots attractive until sometime during summer or even fall. This is true even for what is largely considered the most popular clover blend for attracting deer on the market today, a seed blend known as Imperial Whitetail Clover marketed by Whitetail Institute of North America, Inc.

Thus, merely because wild deer shall eat a plant, does not mean that they eat that plant at any time of the year during which the plant is green and ready for browsing. Furthermore, just because deer are known to eat a particular plant does not suggest that deer eating the plant enhances antler size and/or antler growth.

Consequently, just because deer are known to brows a certain plant including forbs does not suggest to plant a forage plot of the plant that will be sufficiently attractive to wild deer that the deer to repeatedly and reliably visit the forage plot. Furthermore, there exists no hint or suggestion that a plant browsed by deer whose effects on antler growth has not yet been objectively established in any way improves deer antler grow or antler size. In fact, it is a widely held belief that naturally existing forbs provide inadequate forage for optimizing whitetail deer antler growth, and that deer must consume specifically bred hybridized plants to enhance antler growth.

Furthermore, it is a widely held belief that unless a deer and especially whitetail deer consumes such specifically bred hybridized plants in sufficient quantities and for a sufficient period of time, that the wild deer has no chance of reaching its potential maximum genetic antler development. It is widely believe that wild whitetail deer cannot reliably reach their potential maximum antler development with naturally occurring forage even if the deer prefer such naturally occurring forage to hybridized forbs.

The widely held belief regarding attractiveness is that what deer find most attractive is what is most nutritious, and that what is most nutritious for deer, both male and female deer, is what maximizes antler growth in male deer for a certain soil type as the male deer are thought to maximize antler growth only when all their other nutritional requirements are fully satisfied. As mentioned previously, the widely held belief is that only forage provided by hybridized forbs fully satisfy whitetail deer's nutritional requirements.

For this reason, the commercial trend in providing plants exhibiting maximum attractiveness to whitetail deer and antler development focuses on hybridizing forbs principally clovers, chicories and alfalfas. This trend seeks out and hybridize varieties of crop variants of clovers, alfalfas, chicories and the like for their mineral and protein content, minerals and proteins being considered the key ingredients for both maximally nutritious forage as well as maximally attractive forbs.

Examples of seeds for deer forage plots are those marketed under the brand names of:
1. “Imperial Whitetail Clover” and “Imperial Alfa-Rack Plus” marketed by the Whitetail Institute of North America, Inc., 239 Whitetail Trail, Pintala, Alabama;
2. “Tecomate Bucks and Bosses Mix” marketed by Tecomate Seed® a division of Barenbrug USA, Inc., 33477 Highway 99#, P.O. Box 239, Tangent, Oreg.; and
3. “Biologic “Maximum”, marketed by Mossy Oak Biologic Seed Co., 206 East Main Street, P.O. Box 757, West Point, Miss.

Forage plot planting for Quality Deer Management (“QDM”) is an increasingly popular practice among land managers managing wild deer herds present on their land. However, several problems continue to plague land managers beyond breeding and providing forbs that are maximally attractive to whitetail deer, and that are also capable of:
1. maximizing antler growth of whitetail deer;
2. maximizing body size of whitetail deer;
3. optimizing the healthfulness of whitetail deer individually and in herds;
4. providing large amounts of forage in a short interval, perhaps a few months, after sowing the forb's seeds;
5. providing forage that is maximally attractive for as much of the year as possible particularly for as much of the whitetail deer's antler growing period of the year as practicable.

One of the problems land managers encounter is acidic soil. Specifically, soils having a pH lower than 6.5 to 7.0 are considered to be acidic soils for the purposes of this disclosure. A problem that has not been solved and represents a long felt need is establishing forage plots in acidic soils that increases antler size and enhances antler growth using a highly productive forb that is sufficiently attractive to deer so as both:
1. tolerate heavy browsing; and
2. induce deer to routinely visit and browse that forage during spring green-up, spring, summer and early fall, i.e. during the antler growing seasons.

Thus far a forb has not been identified that can be economically established in acidic soil in a short interval so that it quickly becomes a deer forage plot, for example a fall planting ready for heavy spring and summer browsing in less than one year, and particularly in less than a six month interval. The most popular forbs for attracting deer that enhance antler growth and generate large amounts of forage in a relatively short period of time, for example clovers, alfalfa varieties and some chicories, require a soil that is less acidic than the vast majority of soils available for wild deer forage plots. Neutralizing soil acidity generally requires intensive liming both to establish and to maintain a deer forage plots. While lime itself is not very expensive, the cost of associated machinery to spread and till lime into the soil and the machinery's operation is expensive. Furthermore, in areas inaccessible to such machinery, such as remote hunting locations, liming is impractical.

For remote areas, due to soil acidity, a forb that is highly attractive to deer during the spring and summer has not been identified. Furthermore, remote areas require a forb that can be successfully grown by broadcasting the forb's seed onto untilled soil. Thus far, despite claims to the contrary all known varieties of deer forage forbs that can be successfully grown by broadcasting the forb's seed onto untilled soil have not been scientifically proven to enhance antler growth or increase antler mass. Furthermore, forbs that can be successfully grown by broadcasting the forb's seed onto untilled soil have not been scientifically proved to attract wild deer during spring or even summer months.

Another difficulty plaguing establishment of deer forage plots is that thus far a forb has not been identified that:
1. can be economically and easily planted during the fall, and be sufficiently grown and ready for sustained browsing by wild deer at normal population levels during the following spring; and
2. has the additional property of being sufficiently attractive to wild deer so as to repeatedly attract deer during spring green-up or shortly after spring green-up and during spring.
   Presently, only bean forbs have been proposed for attracting deer during spring. The problem is that such bean forbs do not grow in much of North America, much of the range of the whitetail deer, because spring temperatures are too cold. Generally, soil temperatures must be above an average of about 65° F. for bean forbs growth. This means that even where bean forbs grow in the spring they are unavailable during spring green-up because that is when the forb's seeds may be germinating so the forb becomes available rather later in the spring.

A forb that repeatedly attracts deer during spring green-up has several advantages. For example, if a particular forb is maximally nutritious and highly attractive to deer during spring green-up it assists deer in recovering their weight and health at the end of winter when wild deer health is at its poorest. Another advantage is that the sooner wild whitetail deer commence eating nutritious food after winter, the sooner the deer recover their optimal body mass and then begin growing large antlers. Whitetail deer must first optimize their skeletal and other systems' healthfulness before their bodies can dedicate energy toward growing large antlers. Yet another advantage is that the presence of such forage during spring green-up encourages wild deer to remain in the vicinity of a particular forage plot during the remainder of the year if forage remains available. Since it is most difficult to attract wild deer to a forb forage during spring green-up, a forb that deer find attractive during spring green-up shall by extension also remain attractive during the remainder of the year when the forb is lush and grown.

Having a forb that attracts deer during spring green-up combined with other forage for attracting deer during winter such as brassicas, allows land managers to have the deer attracted and present on their property during the entire year. Having wild deer remain at a particular locale year round is a foremost goal of most entities planting forage plots for wild deer. When the wild deer remain at a particular locale, they can also be monitored year round for future selection. Wild deer remaining in a particular locale permits providing them with proper nutritional supplements, e.g. forage plots and mineral supplements intended for use during different times of the year and seasons including winter, so as to maximize deer health and favorable growth characteristics facilitating QDM practices.

A main difficulty in providing a forb having the above mentioned favorable characteristics and that also is attractive to deer during spring green-up is that spring green-up is when nature provides the most nutritious food sources for hungry deer having survived a winter. Spring green-up food sources include sprouting new vegetation that rich in minerals and other vital compounds. Thus deer usually favor their natural food during spring green-up. Consequently, any forb that is sufficiently attractive to deer during spring green-up to the extent that wild deer repeatedly seek it out is a forb that should be considered “highly attractive” to and “preferred” by wild deer. It is generally believed that any food deer find highly attractive or preferred during spring green-up would also be highly attractive and preferred by deer during the balance of the year if the forage remains available in the same form as during spring green-up.

As indicated above and discussed in more detail below, further problems include that it is often expensive to establish forage plots most attractive to wild deer using currently commercially available products such as popular clover blends, alfalfa blends and chicories. Because such forbs tolerate a narrow range of soil acidity, establishing forage plots using them frequently requires time, energy and resources for repeated lime applications. For chicories, the high cost of establishing a forage plot is acerbated by a high cost for reproducing and harvesting the forb's seed since chicory plants produce relatively little seed. Those commercially available forage forbs that tolerate more acidic soils and are less costly to establish, such as brassicas, have the disadvantage of not being preferred by wild deer during spring green-up or even summer. As stated previously, wild deer do not seek out brassicas until fall, especially after a hard frost, such as during late fall and winter.

Thus, a long felt need continues to exist for a forb that can economically and easily be reproduced and planted to provide whitetail deer forage in soils that are too acidic for optimal clover growth and that exhibits an attractiveness similar to that of clovers.

Thus, a long felt need continues to exist for a forb that can economically and easily be reproduced and planted as whitetail deer forage by being broadcast over untilled soil and that exhibits an attractiveness similar to that of clovers.

Thus, a long felt need continues to exist for a forb that can economically and easily be reproduced and planted as whitetail deer forage by broadcasting over untilled soil that is too acidic for optimal clover growth and that exhibits an attractiveness similar to that of clovers.

Thus, a long felt need continues to exist for a deer forage forb that is more attractive to wild whitetail deer during spring green-up than existing clovers.

Thus, a long felt need continues to exist for a deer forage forb that is attractive to wild whitetail deer during spring green-up, and especially that is highly attractive to whitetail deer during spring.

Thus, a long felt need continues to exist for a deer forage forb that is attractive or highly attractive to wild whitetail deer during spring even in cooler regions of the whitetail deer's range, especially cooler regions of North America where it is too cold to grow forage beans during early spring.

Thus, it can be appreciated that a long felt need continues to exist for a deer forage forb that is attractive and highly attractive to wild whitetail deer during the antler growing season of spring and summer.

Thus, a long felt need continues to exist for a forb that satisfies any and especially all of the above criteria while also enhancing the healthfulness and survival rate of wild whitetail deer.

Thus, a long felt need continues to exist for a forb that satisfies any and especially all of the above criteria while also enhancing antler growth and increasing antler size and increasing antler mass of wild whitetail deer.

Thus, a long felt need continues to exist for a forb that can be easily planted by being broadcast over untilled acidic soil near crops such as trees for the purpose of sacrificially deterring deer from browsing such crops including tree crops. Also, a long felt need exists for a forb that can satisfy any of the preceding long felt needs while also being attractive to turkeys, e.g. wild turkeys.

As stated previously, the trend in the industry in attempting to address the preceding long felt needs is to hybridize certain species of plants that are largely used in agriculture and for which there is a large history of scientific selection and breeding. Such plants include forbs of clovers, chicories, alfalfas, and also plants such as wheats, oats, rye and others. Furthermore, it is a trend in the industry to eradicate all weeds and all plants typically known as weeds from the vicinity of deer forage plots. Allocating significant resources and marketing to encourage applying herbicides for eradicating and controlling weeds at wild whitetail deer forage plots is the norm and the trend in the industry.

### BRIEF SUMMARY

An object of the present disclosure is to provide an easily established forb for a wild deer forage plots that whitetail deer find highly attractive during spring green-up and which whitetail deer repeatedly browse during spring green-up.

Another object of the present disclosure is to provide an easily established forb for a wild deer forage plots that is superior at attracting wild whitetail deer during spring.

Another object of the present disclosure is to provide an easily established forb for a wild deer forage plots that is superior at attracting wild whitetail deer during spring in locals where it is too cold to grow beans during early spring.

Another object of the present disclosure is to provide an easily established forb for a wild deer forage plots that is attractive to wild whitetail deer during spring while also being more beneficial to antler growth, including being more beneficial at increasing antler size and increasing antler mass.

Another object of the present disclosure is to provide an easily established forb for a wild deer forage plots that is superior at attracting wild whitetail deer during spring, summer and autumn.

Another object of the present disclosure is to provide seed for easily established forage plots of forb that is tolerant to soil conditions considered too acidic for optimal growth of most clovers, and especially being tolerant to somewhat acidic soils.

Yet another object of the present disclosure is to provide an easily established forb for a wild deer forage plots that can be established without extensive ground tillage, but rather by eradicating existing weeds and ground cover with simple mechanical and herbicide techniques.

Yet another object of the present disclosure is to provide an easily established forb for a wild deer forage plots that can be economically established in acidic soil in a short interval thus providing forage for whitetail deer quickly, particularly in less than six (6) month.

Yet another object of the present disclosure is to provide a seed for a forb having the properties as described in any one of the preceding objects of the present disclosure that also grows well in what are generally considered to be low sunlight conditions.

Yet another object of the present disclosure is to provide a seed for a forb having the properties as described in any one of the preceding objects of the present disclosure that is easily reproduced and harvested.

Yet another object of the present disclosure is to provide a forb having the properties as described in any one of the preceding objects of the present disclosure that increases wild whitetail deer health and body mass.

Yet another object of the present disclosure is to provide a forb having the properties as described in any one of the preceding objects of the present disclosure that is able to attract wild whitetail deer to forage plots, including already established forage plots, that include less attractive forbs and that induces wild whitetail deer to feed on or habituate visiting locals of forage plots having the less attractive forb, such as plots of clover, chicory, burnet, alfalfa or pre-frost brassicas, to thereby accustom wild whitetail deer to browsing in a local that also includes winter forage such as brassicas.

Briefly, one aspect of the present disclosure is a method for preconditioning a whitetail deer forage plot. The disclosed whitetail deer forage plot preconditioning method includes the steps of:
1. selecting an area of soil to be preconditioned in a locale accessible to whitetail deer; and
2. sowing plant seed in the selected area of soil that includes Lapsana communis seed.
   In another aspect, the present disclosure is a method for preparing a seed blend for use in sowing a forage plot for whitetail deer. The seed blend preparation method includes the steps of:
1. selecting a seed type other than Lapsana communis seed for inclusion in the seed blend; and
2. combining a first quantity of plant seed of the selected seed type other than Lapsana communis seed with second quantity of Lapsana communis seed to thereby produce the seed blend.

These and other features, objects and advantages will be understood or apparent to those of ordinary skill in the art from the following detailed description of the disclosure and the illustrations of the various drawing figures.

### BRIEF DESCRIPTION OF THE DRAWINGS

FIG. 1 depicts seeds of the forb disclosed herein that may be advantageously sowed in deer forage plots as the forb's seeds appear in U.S. National Seed Herbarium image: Fruits of Lapsana communis, (PI 144515) collected by T. H. Goodspeed from Aconcagua, Chile and photographed by Steve Hurst for the USDA-NRCS PLANT Database, and obtained from The PLANTS Database National Plant Data Center, Baton Rouge, La. 70874-4490 USA;

FIG. 2 depicts the inventive forb when viewed looking down on several inventive forb's plants as the forb's plants appear in Plants of Hawaii Image 020808-0048 Flowers at Polipoli, Maui, Aug. 8, 2002, photographed by Forest & Kim Starr;

FIG. 3 depicts the inventive forb in an elevational view of the inventive forb's plant as the forb's plant appears in Plants of Hawaii Image 050831-4254 Habit at Polipoli, Maui, Aug. 31, 2005, photographed by Forest & Kim Starr; and

FIG. 4 depicts the inventive forb in an elevational view of the inventive forb that includes flowers and forming seed pods as the forb's plant appears in Plants of Hawaii Image 020808-0047 Flowers at Polipoli, Maui, Aug. 8, 2002, photographed by Forest & Kim Starr.

### DETAILED DESCRIPTION

It has been discovered that, surprisingly, shockingly and contrary to customary belief, a wild plant considered to be a weed having a Latin name of Lapsana communis, and a common name of “common nipplewort” (herein “the inventive forb”), is superior for attracting wild whitetail deer, blacktail deer, coues deer and mule deer during spring, summer and autumn than all known forbs whose seeds are marketed and sold for establishing wile deer forage plots. Furthermore, sowing seeds of the inventive forb yields a forage plot that attracts wild deer including during spring green-up in regions too cold to grow forage beans during early spring.

The term “inventive forb” as use herein includes any and all:
1. subspecies of Lapsana communis; and
2. future hybridized variants of Lapsana communis, the breeding of which the following disclosure is likely to encourage.
   The terms “North American whitetail deer and “whitetail deer” as used herein includes North American whitetail deer, blacktail deer, coues deer and mule deer.

The “Interactive Agricultural Ecological Atlas of Russia and Neighboring Countries. Economic Plants and their Diseases, Pests and Weeds” describes the inventive forb as follows.

Weeds
Lapsana communis L.—Common Nipplewort

Systematic Position.
Family Asteraceae Dumort. (Compositae), genus Lapsana L.

Biological Group.
This species is an annual weed.

Morphology and Biology.
The root is stalky. Root system is well developed. Stalk is straight, simple or branchy, 20-100 cm in height, hollow, ridged from above, often reddish green, glabrous or pubescent in the lower part, with simple hairs or with an impurity of glandular hairs. Leaves are thin, soft, pubescent and dentate along margin. Phyllotaxy is alternate. The lower and middle stem-leaves are lyre-shaped and pinnatisected, with a large heart-shaped terminal lobe and 1-3 pairs of lateral lobes, decreasing in size toward base of petiole. Lower or middle leaves have a long petiole which is slightly winged and hairy. The upper leaves are fewer in number and smaller in size; they are usually lanceolate or narrowly ovate, sessile, lacking lobes of any kind. The plant terminates in a large spreading paniculate inflorescence with hairless branches. Flower heads are numerous, fine, up to 15 mm in diameter, each containing 8-20 yellow ligulate florets. Each ligulate flower ends with 5 small teeth. Anthers of stamen are long and brown, with a sagittate base. Receptacle is flat and bare. Involucre is campanulate or cylindrical, 2-4 mm wide and about 5-7 mm long, glabrous, biseriate. External leaflets short, ovoid, 3-5 in number. Internal leaflets long, oblong-linear, with a thick rib from above, 8-10 in number. External leaflets are 5-7 times shorter than internal ones. Achenes are brownish, 3-4 mm long, 1 mm wide, and 0.5 mm thick, glabrous, flat, slightly curved, narrowed toward both ends, with blunt tip. There are 20 thin small longitudinal costulae on surface of the achene. Pappus and rostellum are absent. The plant winters as a rosette of leaves, blossoming from June until September, reproducing by seeds. Some achenes drop in fields and litter the ground, some get into grains of cultivated plants. They are easily separated from grains. In dry conditions they maintain their germinating ability for six years. Unripe and mature achenes sprout at the same rate.

Distribution.
This is a Euroasian forest species of the temperate climate zone, described from Western Europe. The general distribution includes the following areas: Europe, northern Iran, Northern Africa, the western Himalayas. This is an alien species in Northern America. In the former USSR it is distributed in the European part and the Caucasus. The species is occasionally found in the Southwest of Siberia (foothills of Altai) and in Central Asia (Kopet Dagh, vicinities of Almaty and Toshkent). It was brought to the Far East in the second half of 20th century.

Ecology.
The plant grows in shady and humid places. In natural habitats the species is distributed in the forest zone in forests, on forests edges, along banks of water reservoirs. It is also found in ruderal places, i.e., along roads and fields, in fallow lands, in segetal habitats. It litters crops, fields, kitchen gardens, gardens, and parks. It is found in crops frequently, but not abundant.

Economic Significance.
Young leaves and stalks contain 84 mg/g (dry weight) or 16 mg/g (crude weight) of carotin, i.e., more than carrots. Five glycosides were identified in the latex of L. communis. Young plants can be used for salads and soups. The plant is also edible to cattle. The plant litters crops in the forest zone with a small abundance, to 2 points. It litters 1% of fields in northern taiga and 14% of fields in middle taiga and south to forest-steppe. Authors describe it as a widespread weed. This plant frequently litters winter crops and crops of perennial grasses, less often summer cultures.

Control Measures.
Do not contaminate sowing material or ground with seeds of the weed. Mow off or pull up the weed before fructification. It is necessary to remember that good results in the struggle against the weed can be only reached with a combination of agronomical and chemical methods.

### REFERENCE CITATIONS

Keller B. A., Lyubimenko V. N., Maltsev A. I., Fedtshenko B. A., Shishkin B. K., Rodzevich R. Yu., Kamenskii K. V., eds. 1935. Weed plants of the USSR. V. 4. Moscow-Leningrad: AN USSR. 414 p. (In Russian)
Shlyakova E. V. 1982. Keys to field weed plants of Non-Chernozem zone. Leningrad: Kolos. 208 pp. (In Russian)
Ulyanova T. N. 1998. Weed plants in flora of Russia and other FSU countries. Saint Peterburg: VIR. 233 pp. (In Russian)
   “Vascular Plants of the Pacific Northwest,” Vol. 5, describes the inventive forb as follows.
   Lapsana communis L. Sp. P1. 811. 1753. (Europe) Hirsute to subglabrous annual weed 1. 5-15 dm. tall, with a single erect stem; leaves thin, petiolate, with ovate to subrotund, obtuse or rounded, toothed or occasionally basally lyrate blade mostly 2. 5-10 cm. long and 2-7 cm. wide, progressively less petiolate and eventually narrowed upwards; heads several or many in a corymbiform or paniculiform inflorescence, the peduncles tending to be apically pale and indurated; involucre usually 5-8 mm. high, with mostly 8 relatively narrow and firm bracts that are evidently keeled at least toward the base and remain erect at maturity; flowers commonly about 13; achenes 3-5 mm. long, glabrous, curved; pappus none.

Nipplewort.
A weed in fields and disturbed sites, less commonly in woodland; native of Eurasia, now widely established in n. U.S. and adj. Can., in our area more common w. of the Cascade Mts. Mostly June-July.
   While the preceding sources provide differing descriptions for certain aspects of the inventive forb, such inconsistencies can be attributed to differences in climate, soil type and growing conditions.

When planted densely together, and especially when either young or subject to heavy browsing, the inventive forb provides lush, tender green foliage including young tops that wild deer find highly attractive. When young and when heavily browsed or pruned, the inventive forb produces new foliage that is lush and tender, and can be a full bodied green color. The inventive forb is so attractive that whitetail deer have been observed seeking it out continually during spring green-up, and during other times of the year when healthy inventive forb is available. That is, whitetail deer browse the inventive forb when it is not dry or coarse due to seed pod maturation, etc. Whitetail browsing the newly forming tops of the inventive forb delays seed pod production until the foliage becomes so coarse that the deer stop browsing the plant. The more the inventive forb is browsed and/or mowed, the smaller its seeds tend to be.

The inventive forb may be sown to becomes available during an optimum time of year. Seed of the inventive forb may be simply broadcast into an existing wild deer forage plot, i.e. “over seeding,” to established plots of the inventive forb. Germination and growth occurs when sufficient moisture is present, especially as rainfall. Consequently, the inventive forb can be advantageously sown during:
1. autumn, to make available during late autumn (if climate allows) and during spring; and also
2. spring, to make available during late spring and summer; and also
3. summer, to make available during autumn and late autumn, into early winter.

The inventive forb may be sown in soil conditions that include:
1. any soil having a Ph in which clover grows well;
2. soils that are more acidic than that in which clover grows well;
3. soils customarily considered to be well drained; and
4. soils in low sunlight conditions, e.g. shaded areas.
   After sufficient moisture permits the inventive forb to germinates and become well established, it can tolerate some drought.

A whitetail deer forage plot can be easily established without extensive tillage. Such a whitetail deer forage plot may be established by:
1. eradicating existing weeds and ground cover with simple mechanical and herbicide treatment, for example weed whacking followed by application of glyphosate; and
2. then broadcasting seeds of the inventive forb.

Seed of the inventive forb may be advantageously combined with seeds of other forbs and/or plants so a resulting forage plot contains a variety of plants. Blending seeds of the inventive forb with seeds of other whitetail deer forage crops establishes a forage plot that attracts whitetail deer during spring green-up and as long as the inventive forb remains healthy. Thus, as the seasons progress and when naturally available forage for deer diminishes deer are already accustomed to visiting the plot where other forbs are growing together with the inventive forb. Thus, when whitetail deer no longer browse the inventive forb, perhaps because it was totally consumed or perhaps because it has gone to seed, the deer can then begin browsing other forbs in the plot. Applicant has used the preceding method successfully by combining seeds of the inventive forb with seeds sold commercially under the trade names Imperial Whitetail Clover® and Imperial Whitetail Extreme®.

To provide a year-round food plot highly attractive to whitetail deer, the inventive forb can be advantageously combined with any or all of plants that are of a type known as: brassicas; beans including soybeans including lab; winter wheat; oat grass; rye grass; brome grass; rape; clovers, alfalfas, chicories; and spring and summer forage beans. Combining the inventive forb with brassicas and soybeans is particularly useful for post-frost autumn and winter forage, and combining with clovers, alfalfas, chicories and spring and summer forage beans is especially useful for providing summer forage should the inventive forb be totally consumed or have gone to seed prior to autumn frost and early winter.

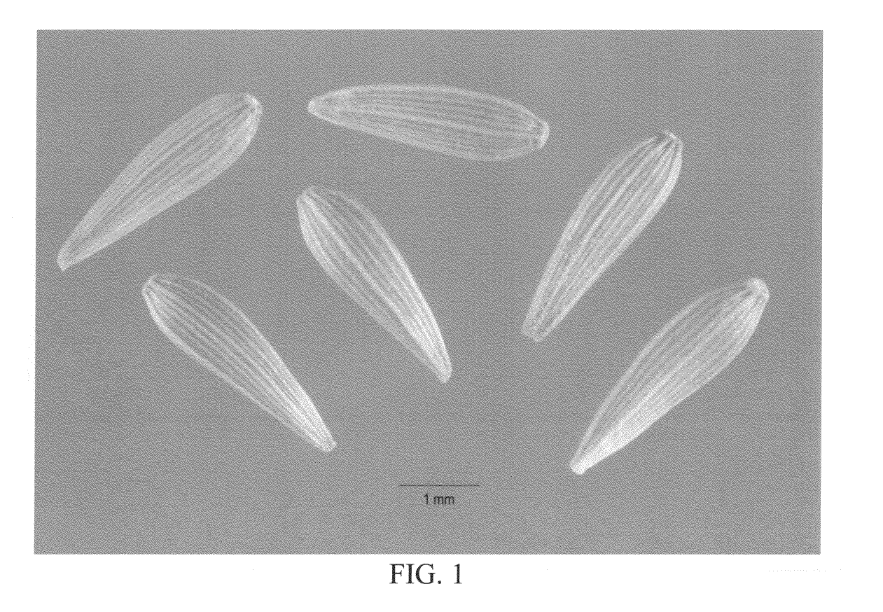

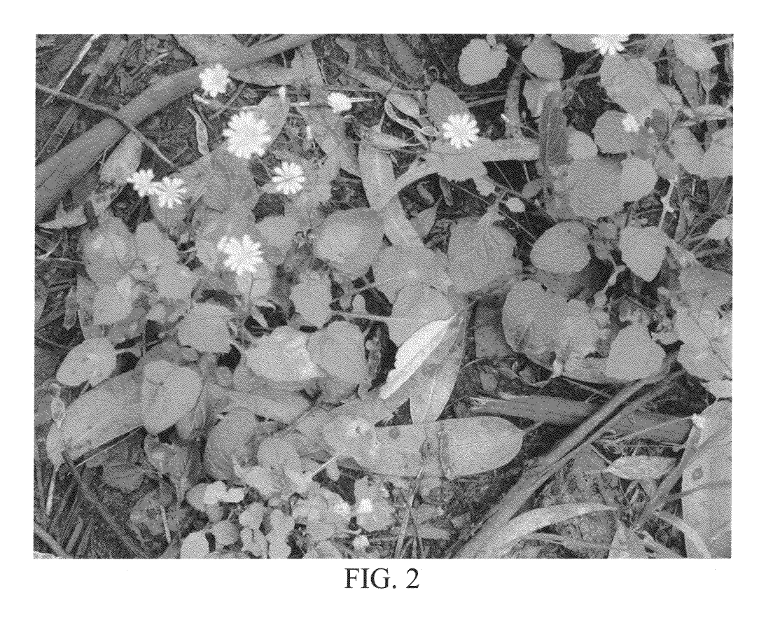

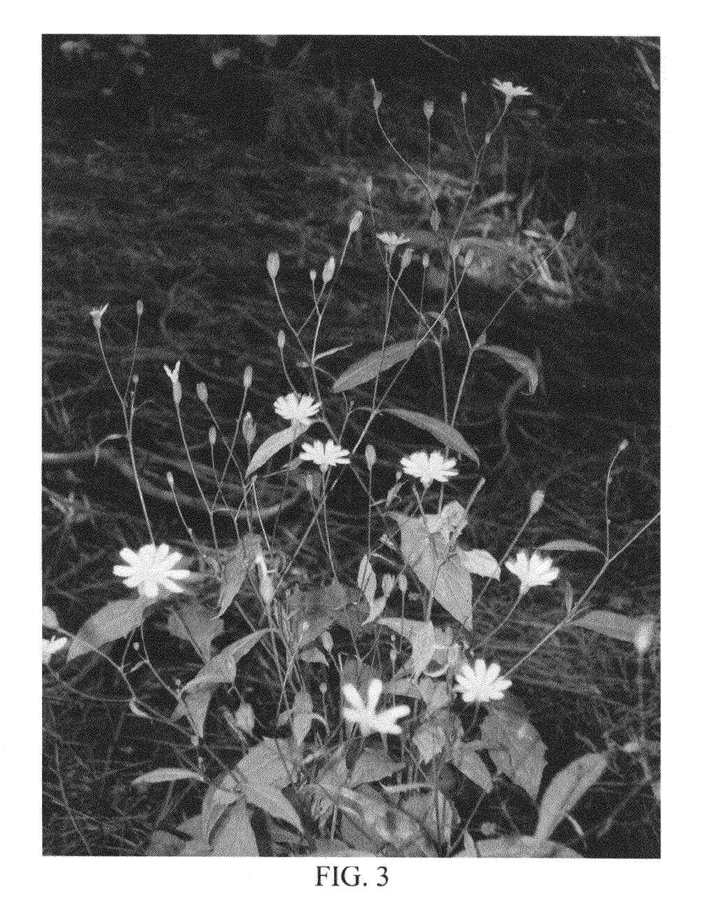

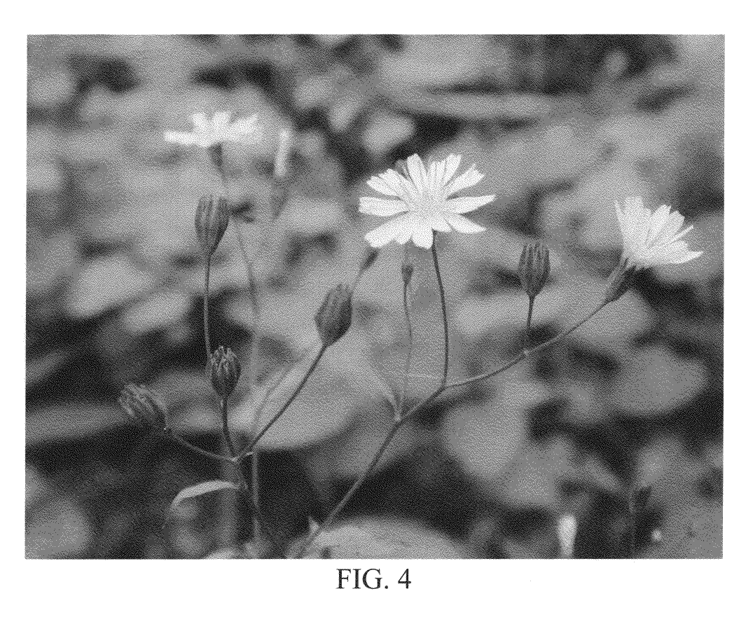

FIG. 1 depicts seeds of the inventive forb. FIG. 2 depicts the inventive forb looking down on several inventive forb plants. FIG. 3 is an elevational view of the inventive forb. FIG. 4 is an elevational view of the inventive forb that includes flowers and forming seed pods.

It has been discovered surprisingly, shockingly and contrary to the customary belief that the inventive forb depicted in FIGS. 1-4 improves antler growth and increases antler size of wild north American whitetail deer that browse forage plots of the inventive forb. Sowing of seeds of the inventive forb to establish a whitetail deer forage plot having the inventive forb produces improved antler growth and increase antler size of wild whitetail deer.

It has also been discovered surprisingly, shockingly and contrary to the customary belief that wild North American whitetail deer having access to forage plots of the inventive forb exhibit improved antler growth and increased antler size of wild whitetail deer in comparison with whitetail deer that browse forage plots lacking the inventive forb including forage plots that have forage beans or other known forbs. Sowing seeds of the inventive forb during the autumn, winter and even spring establishing a forage plot that supplies whitetail deer with the inventive forb during spring green-up and/or spring, and also following summer.

It has been discovered surprisingly, shockingly and contrary to the customary belief that whitetail deer having access to forage plots of the inventive forb exhibit increases health and body mass. Providing whitetail deer with access to forage plot having the inventive forb increases their health and body mass.

It has been found, surprisingly, shockingly and contrary to the customary belief that the inventive forb repeatedly and reliably attracts whitetail deer during spring green-up, during spring, also during summer and autumn, and even during a sufficiently warm winter. Sowing seeds of the inventive forb establishes a whitetail deer forage plot that repeated and reliable attracts wild whitetail deer.

It has been found, surprisingly, shockingly and contrary to the customary belief that the inventive forb easily establishes a forage plot having any or all of the preceding characteristics. Furthermore, the inventive forb is more tolerant of soil conditions considered too acidic for optimal growth of most clovers, and especially being tolerant of somewhat acidic soils, especially soils having a pH level lower than 6.5 to 7.0. Accordingly, sowing seeds of the inventive forb in soils having a pH level lower than 6.5 to 7.0 establishes a whitetail deer forage plot having any or all of the preceding characteristics.

It has been found, surprisingly, shockingly and contrary to the customary belief that the inventive forb can be easily established in a forage plot having any or all of the preceding characteristics in conditions that are customarily considered to be low sunlight. Furthermore, in whitetail deer forage plots the inventive forb tolerates both dry conditions and heavy browsing.

It has been discovered surprisingly, shockingly and contrary to the customary belief that the inventive forb effectively protects crop trees, crop plants and decorative plants from wild whitetail deer browsing. Sowing the inventive forb in a perimeter around and also interspersed among crop trees and other plants, including fruit trees, crops and decorative plants, to be protected from whitetail deer browsing noticeably decreases deer interest in and browsing of such crop trees, crops and other plants because wild whitetail deer preferentially browse the inventive forb.

It has been discovered surprisingly, shockingly and contrary to the customary belief that, rather than eradicating weeds from forage plots planted with human hybridized plant varieties, that the inventive forb is more attractive to deer when it is deliberately and densely planted in plots rather than when it is randomly interspersed with naturally occurring forage.

More specifically, a significant aspect of the present disclosure is the surprising and shocking discovery that the inventive forb can be used in specific way to better whitetail deer health and antler growth. Uncultivated, naturally occurring L. communis generally covers approximately two and one-half percent (2.5%) of perhaps a one-eighth (⅛) area. Specifically, in accordance with the present disclosure the inventive forb can be advantageously planted throughout a selected area of soil (“soil” including rocks and other ground debris) having an area of at least one-eighth (⅛) acre. This specific way of using the inventive forb further includes sowing a quantity of Lapsana communis seed to obtain a density of L. communis in the selected soil area that exceeds by a factor of as much as two (2) the density of naturally occurring L. communis. That is, the one-eighth (⅛) acre area sown with Lapsana communis seed in accordance with the present disclosure produces as much L. communis as would normally grow in a one-quarter (¼) acre area. This high density of L. communis in the forage plot sown with the inventive forb has been observed to significantly enhance whitetail deer antler growth.

To further attract and enhance antler growth of whitetail deer, the selected area of soil sown with Lapsana communis seed to produce a density of L. communis double that would occur naturally is preferably at least one-quarter (¼) acre. Even larger areas such as one-half (½) acre and even one (1) acre may be advantageously sown to produce L. communis at twice the density that would naturally occur. Furthermore, L. communis cultivated at this double density can be interspersed with other plants such as brassicas, clovers, chicories, alfalfas, forage beans and other legumes.

For example, in order to attract whitetail deer to a particular locale perhaps for the purpose of inducing browsing by whitetail deer of other less attractive but already established forage such as brassicas, clover, chicory, burnet and/or alfalfa, it is taught:
1. to mix seeds of the inventive forb with seeds of other known forage forbs as well as with seeds of Anemone nemorosa; and
2. to then sow the seed mixture in order to establish forage plots that both attract to whitetail deer and enhance their antler growth and increase antler mass.
   Alternatively or additionally, linearly shaped forage plots containing solely or mainly the inventive forb interspersed among, border on and/or pass through forage plots containing other forbs can be highly advantageous. The present disclosure teaches also teaches a variant of the inventive forb where the typically hairy structures on the underside of the leaves of L. communis are greatly reduced or not readily discernible, and even are absent.

Applicant has observed twin 2.5 year old bucks where one buck that accessed the inventive forb exhibited 30-50% more antler growth in comparison with its twin that did not access to the inventive forb. Applicant has also compared forage plots of the inventive forb with forage plots of “control” forbs that include Imperial Whitetail Clover®, Imperial Extreme® (including Imperial chicories, burnets and clovers) that are reputedly more attractive to whitetail deer than other commercially promoted forbs. During spring green-up and also during spring and early summer in western Washington state, Applicant observed that the inventive forb was the only forb heavily browsed of all the forbs tried. Heavy browsing by wild whitetail deer continued throughout spring, summer, autumn and apparently into early winter—though monitoring of browsing was not regularly conducted in early winter as the control forbs were by then also being browsed. Early winter is a time when wild whitetail deer in western Washington state normally browse such control forbs. Applicant attributes this observation to the fact that whitetail deer are likely to browse a certain forb during a certain season and not necessarily during other seasons.

Applicant also observed that the inventive forage plots of inventive forb tolerate heavy browsing, growing quickly and well, in conditions that are customarily considered to be:
1. low sunlight;
2. acidic soils, i.e. Ph levels lower than 6.5 to 7 and/or considered too acidic for most clovers;
3. well drained soils; and
4. dry soils.

Applicant further observed that the inventive forb propagates both in “now plow” and in “no till” plots, and that it is not overly sensitive to herbicides such as glyphosate and RoundUp while also readily able to be controlled thereby.

Applicant also observed that lactating does prefer forage plots of the inventive forb as well as bucks developing antlers in comparison with the control forbs. Wild whitetail deer browsing forage plots of the inventive forb exhibited noticeably greater healthfulness than that of other whitetail deer in the area that were unable to browse those forage plots due to territorial nature of the lactating does in the vicinity of the plots. The very high healthfulness of the observed whitetail deer is due perhaps to their consumption of large quantities of the inventive forb which may result in parasite control.

Although the present invention has been described in terms of the presently preferred embodiment, it is to be understood that such disclosure is purely illustrative and is not to be interpreted as limiting. For examples, there exists differences among descriptions of the inventive forb in various different botanical references as well as sub-types and future hybridizations. Applicant intends that the following claims encompass Lapsana communis as described in all various different botanical references. Consequently, without departing from the spirit and scope of the disclosure, various alterations, modifications, and/or alternative applications will, no doubt, be suggested to those skilled in the art after having read the preceding disclosure. Accordingly, it is intended that the following claims be interpreted as encompassing all alterations, modifications, or alternative applications as fall within the true spirit and scope of the disclosure including equivalents thereof. In effecting the preceding intent, the following claims shall:
1. not invoke paragraph 6 of 35 U.S.C. §112 as it exists on the date of filing hereof unless the phrase “means for” appears expressly in the claim's text;
2. omit all elements, steps, or functions not expressly appearing therein unless the element, step or function is expressly described as “essential” or “critical;”
3. not be limited by any other aspect of the present disclosure which does not appear explicitly in the claim's text unless the element, step or function is expressly described as “essential” or “critical;” and
4. when including the transition word “comprises” or “comprising” or any variation thereof, encompass a non-exclusive inclusion, such that a claim which encompasses a process, method, article, or apparatus that comprises a list of steps or elements includes not only those steps or elements but may include other steps or elements not expressly or inherently included in the claim's text.

1. A method for preconditioning a whitetail deer forage plot comprising the steps of:
a. selecting an area of soil to be preconditioned in a locale accessible to whitetail deer; and
b. sowing plant seed in the selected area of soil that includes Lapsana communis seed.

2. The method for preconditioning of claim 1 wherein before sowing Lapsana communis seed in the selected area of soil, the method for preconditioning including the further step of:
c. mechanically eradicating weeds and ground cover existing in the selected area of soil.

3. The method for preconditioning of claim 2 wherein mechanically eradicating weeds and ground cover existing in the selected area of soil includes weed whacking.

4. The method for preconditioning of claim 2 wherein before sowing Lapsana communis seed in the selected area of soil, the method for preconditioning including the further step of:
d. eradicating weeds and ground cover existing in the selected area of soil by applying a herbicide thereto.

5. The method for preconditioning of claim 4 wherein the herbicide applied to the selected area of soil includes glyphosate.

6. The method for preconditioning of claim 1 wherein the selected area of soil is at least a one-eighth (⅛) acre area, and the method for preconditioning further includes the step of sowing a quantity of Lapsana communis see to produce a density of L. communis in the selected area of soil that exceeds a density of naturally occurring L. communis thereby bettering whitetail deer antler growth.

7. The method for preconditioning of claim 6 wherein the selected area of soil is at least a one-quarter (¼) acre area.

8. The method for preconditioning of claim 6 wherein the selected area of soil is at least a one-half (½) acre area.

9. The method for preconditioning of claim 6 wherein the selected area of soil is at least a one (1) acre area.

10. The method for preconditioning of claim 1 wherein plant seed sewn in the selected area of soil include plant seed in addition to Lapsana communis seed.

11. The method for preconditioning of claim 10 wherein plant seed sewn in the selected area of soil in addition to Lapsana communis seed is a seed chosen from a group consisting of brassicas seed, clover seed, alfalfa seed, chicories seed, legume seed, oat grass seed, rye grass seed, wheat grass seed, bean seed and rape seed.

12. The method for preconditioning of claim 1 wherein the selected area of soil is acidic having a pH level lower than 7.0.

13. The method for preconditioning of claim 1 wherein the selected area of soil is acidic having a pH level lower than 6.5.

14. A method for preparing a seed blend for use in sowing a forage plot for whitetail deer comprising the steps of:
a. selecting a seed type other than Lapsana communis seed for inclusion in the seed blend; and
b. combining a first quantity of plant seed of the selected seed type other than Lapsana communis seed with a second quantity of Lapsana communis seed to thereby produce the seed blend.

15. The method of claim 14 wherein the seed type other than Lapsana communis seed is a seed chosen from a group consisting of brassicas seed, clover seed, alfalfa seed, chicories seed, legume seed, oat grass seed, rye grass seed, wheat grass seed, bean seed and rape seed.

16. The method of claim 14 wherein the second quantity of Lapsana communis seed constitutes no more than seventy-five hundredths percent (0.75%) by weight of the resulting seed blend.

17. The method of claim 14 wherein the second quantity of Lapsana communis seed constitutes no more than one and seven tenths percent (1.7%) by weight of the resulting seed blend.

18. The method of claim 14 wherein the second quantity of Lapsana communis seed constitutes no more than two and forty-five hundredths percent (2.45%) by weight of the resulting seed blend.

19. The method of claim 14 wherein the second quantity of Lapsana communis seed constitutes no more than three and four tenths percent (3.4%) by weight of the resulting seed blend.

20. The method of claim 14 wherein the second quantity of Lapsana communis seed constitutes no more than four and six tenths percent (4.6%) by weight of the resulting seed blend.

21. The method of claim 14 wherein the second quantity of Lapsana communis seed constitutes no more than five and seven tenths percent (5.7%) by weight of the resulting seed blend.

22. The method of claim 14 wherein the second quantity of Lapsana communis seed constitutes no more than fifteen percent (15%) by weight of the resulting seed blend.

23. The method of claim 14 wherein the second quantity of Lapsana communis seed constitutes ho more than fifteen percent (15%) by weight of the resulting seed blend.

24. The method of claim 14 wherein the second quantity of Lapsana communis seed constitutes no more than twenty-two percent (22%) by weight of the resulting seed blend.

25. The method of claim 14 wherein the second quantity of Lapsana communis seed constitutes no more than thirty-three percent (33%) by weight of the resulting seed blend.

26. The method of claim 14 wherein the second quantity of Lapsana communis seed constitutes no more than fifty percent (50%) by weight of the resulting seed blend.

27. The method of claim 14 wherein the second quantity of Lapsana communis seed constitutes more than fifty percent (50%) by weight of the resulting seed blend.
